(19) United States
(12) Patent Application Publication
(10) Pub. No.: US 2023/0299299 A1
(43) Pub. Date: Sep. 21, 2023

(54) ELECTRODE MIXTURE AND RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Kazuya TAGA, Hamamatsu-shi (JP); Ryotaro SAKAI, Toyohashi-shi (JP); Tetsuya KANEKO, Toyohashi-shi (JP); Hiroaki IKEDA, Toyota-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/121,408

(22) Filed: Mar. 14, 2023

(30) Foreign Application Priority Data
Mar. 17, 2022 (JP) 2022-042470

(51) Int. Cl. H01M 4/62; H01M 4/485; H01M 4/36; C01B 32/168

(52) U.S. Cl. CPC H01M 4/625; H01M 4/485; H01M 4/366; C01B 32/168; H01M 2004/021

(57) ABSTRACT

An electrode mixture includes an electrode active material and a carbon nanotube as a conductive fibrous carbon material. The electrode mixture includes an inorganic nanoparticle disposed on a surface of the electrode active material.

### BACKGROUND

### 1. Field

The following description relates to an electrode mixture and a rechargeable battery.

### 2. Description of Related Art

Japanese Laid-Open Patent Publication Nos. 2019-220357 and 2016-31922 disclose an example of an electrode mixture that includes a conductive fibrous carbon material including, for example, carbon nanotubes, and forms an electrode active material layer. In such a structure, the conductive fibrous carbon material forms a conductive path. Thus, a battery having satisfactory properties is obtained.

For example, when a battery is used in an electric vehicle, the battery is required to meet high performance property standards. Therefore, further improvement in properties of the battery has been sought. The conventional structure described above may not satisfy the advancing high performance property standards.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure is an electrode mixture that includes an electrode active material, a conductive fibrous carbon material, and an inorganic nanoparticle disposed on a surface of the electrode active material.

In the electrode mixture described above, the inorganic nanoparticle may have an average diameter of greater than or equal to 25 nm and less than or equal to 150 nm.

In the electrode mixture described above, when an amount of the inorganic nanoparticle contained in the electrode mixture is expressed in weight percent, the amount of the inorganic nanoparticle contained in the electrode mixture may be expressed by an equation of y≤0.0106x−0.0033, where y denotes the amount of the inorganic nanoparticle contained, and x denotes the average diameter of the inorganic nanoparticle.

In the electrode mixture described above, an amount of the conductive fibrous carbon material contained in the electrode mixture may be greater than or equal to 0.5 wt % and less than or equal to 2.0 wt %. A weight ratio of the inorganic nanoparticle to the conductive fibrous carbon material may be greater than or equal to 0.1 and less than or equal to 0.7.

In the electrode mixture described above, a diameter ratio of the inorganic nanoparticle to the conductive fibrous carbon material may be greater than or equal to 1.1 and less than or equal to 3.5.

In the electrode mixture described above, the conductive fibrous carbon material may include a carbon nanotube.

In the electrode mixture described above, the inorganic nanoparticle may include at least one of alumina and lithium tungstate.

Another aspect of the present disclosure is a rechargeable battery manufactured using any one of the electrode mixtures described above.

Another aspect of the present disclosure is a rechargeable battery manufactured using an electrode mixture including an electrode active material and a conductive fibrous carbon material. The electrode mixture includes an inorganic nanoparticle disposed on a surface of the electrode active material. The inorganic nanoparticle has an average diameter of greater than or equal to 25 nm and less than or equal to 150 nm. When an amount of the inorganic nanoparticle contained in the electrode mixture is expressed in weight percent, the amount of the inorganic nanoparticle contained in the electrode mixture is expressed by an equation of y≤0.0106x−0.0033, where y denotes the amount of the inorganic nanoparticle contained, and x denotes the average diameter of the inorganic nanoparticle. An amount of the conductive fibrous carbon material contained in the electrode mixture is greater than or equal to 0.5 wt % and less than or equal to 2.0 wt %. A weight ratio of the inorganic nanoparticle to the conductive fibrous carbon material is greater than or equal to 0.1 and less than or equal to 0.7. A diameter ratio of the inorganic nanoparticle to the conductive fibrous carbon material is greater than or equal to 1.1 and less than or equal to 3.5.

Other features and aspects will be apparent from the following detailed description, the drawings, and the claims.

### BRIEF DESCRIPTION OF THE DRAWINGS

FIG. 1 is a perspective view of a rechargeable battery.

FIG. 2 is an exploded view of an electrode body.

FIG. 3 is a side view of the rechargeable battery.

FIG. 4 is an image diagram of an electron microscopic picture showing an electrode active material and a conductive fibrous carbon material contained in an electrode mixture.

FIG. 5 is an image diagram of an electron microscopic picture showing an electrode active material and a conductive fibrous carbon material located near the electrode active material.

FIG. 6 is an image diagram of an electron microscopic picture showing an electrode active material having surfaces on which inorganic nanoparticles are disposed.

FIG. 7 is a diagram showing an electrode active material, a conductive fibrous carbon material, and inorganic nanoparticles contained in an electrode mixture.

FIG. 8 is an image diagram of an electron microscopic picture showing an electrode active material, the surface of which is free from inorganic nanoparticles.

FIG. 9 is a diagram showing an electrode active material and a conductive fibrous carbon material contained in an electrode mixture that does not contain inorganic nanoparticles.

FIG. 10 is an image diagram of an electron microscopic picture showing an electrode active material, the surface of which is free from inorganic nanoparticles, and a conductive fibrous carbon material located near the electrode active material.

FIG. 11 is an image diagram of an electron microscopic picture showing an electrode active material and a conductive fibrous carbon material contained in an electrode mixture that does not contain inorganic nanoparticles.

FIG. 12 is a table showing test results of the weight ratio of inorganic nanoparticles to carbon nanotubes.

FIG. 13 is a graph showing test results of the weight ratio of inorganic nanoparticles to carbon nanotubes.

FIG. 14 is a table showing test results of the diameter ratio of inorganic nanoparticles to carbon nanotubes.

FIG. 15 is a graph showing test results of the diameter ratio of inorganic nanoparticles to carbon nanotubes.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.

An embodiment of an electrode mixture used in a rechargeable battery will now be described with reference to the drawings.

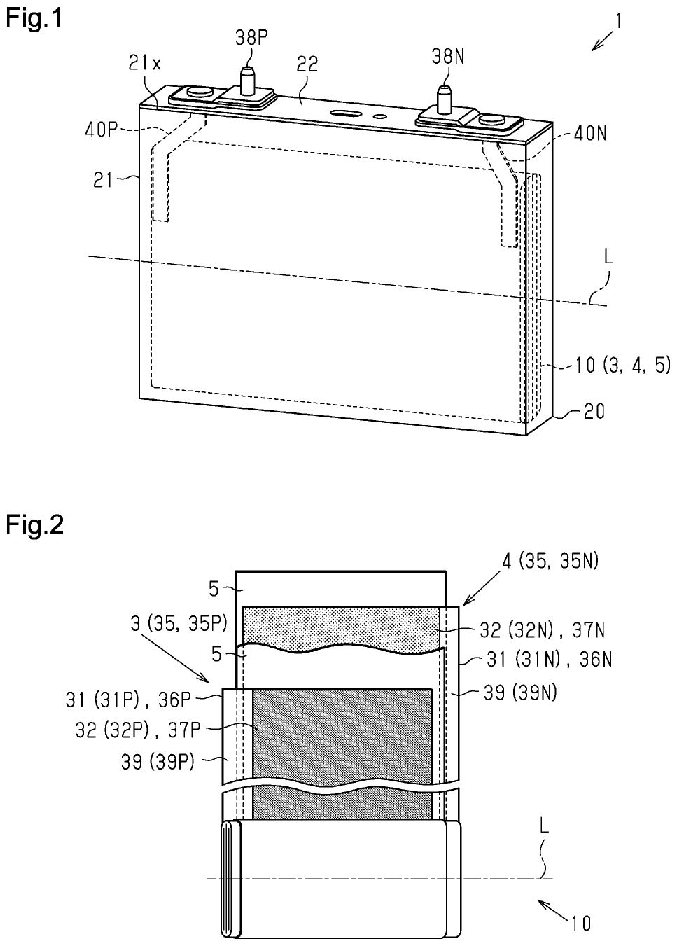

As shown in FIG. 1, a rechargeable battery 1 includes an electrode body 10 and a case 20 accommodating the electrode body 10. The electrode body 10 integrates a positive electrode 3, a negative electrode 4, and a separator 5. The rechargeable battery 1 of the present embodiment is a lithium-ion rechargeable battery in which the electrode body 10 is impregnated with a nonaqueous electrolyte in the case 20.

Specifically, in the rechargeable battery 1 of the present embodiment, the positive electrode 3, the negative electrode 4, and the separator 5 are sheet-shaped and are laminated together. The lamination of the positive electrode 3, the negative electrode 4, and the separator 5 is rolled to form the electrode body 10. In the electrode body 10, the separator 5 is sandwiched between the positive electrode 3 and the negative electrode 4, and the positive electrode 3 and the negative electrode 4 alternate with the separator 5 in the radial direction.

In the present embodiment, the case 20 includes a case body 21 and a lid 22. The case body 21 is low-profile-rectangular-box-shaped and includes an open end 21x. The lid 22 seals the open end 21x of the case body 21. In the present embodiment, the electrode body 10 has a low-profile shape corresponding to the box-shaped case 20.

More specifically, as shown in FIG. 2, in the rechargeable battery 1 of the present embodiment, the positive electrode 3 and the negative electrode 4 each include an electrode sheet 35. The electrode sheet 35 includes a sheet of current collector 31 and an electrode active material layer 32 formed on the current collector 31.

Specifically, in an electrode sheet 35P for the positive electrode 3, a mixture paste 37P includes lithium-transition metal oxide as a positive active material, and a substrate 36P includes aluminum or the like, which forms a positive current collector 31P. The mixture paste 37P is applied to the substrate 36P. Also, in an electrode sheet 35N for the negative electrode 4, a mixture paste 37N includes a carbon-based material as a negative active material, and a substrate 36N includes copper or the like, which forms a negative current collector 31N. The mixture paste 37N is applied to the substrate 36N. The mixture pastes 37P and 37N each contain a binder. In the rechargeable battery 1 of the present embodiment, when the mixture pastes 37P and 37N are dried, a positive active material layer 32P and a negative active material layer 32N are formed on the positive electrode sheet 35P and the negative electrode sheet 35N, respectively.

In the rechargeable battery 1 of the present embodiment, the positive electrode sheet 35P and the negative electrode sheet 35N are each belt-shaped. In the electrode body 10 of the present embodiment, the positive electrode sheet 35P and the negative electrode sheet 35N, between which the separator 5 is sandwiched, are laminated and rolled about a roll axis L that extends in the width-wise direction (sideward direction in FIG. 2) of the belt-shaped sheets.

In FIG. 2, when the electrode sheet 35P, which forms the positive electrode 3, is located inward, the separator 5 and the electrode sheets 35 are rolled. The structure of the electrode body 10 shown in FIG. 2 is an example. Alternatively, when the electrode sheet 35N, which forms the negative electrode 4, is located inward, the separator 5 and the electrode sheets 35 may be rolled. This determines whether the electrode sheet 35 located at the outermost shell of the electrode body 10 is defined by the electrode sheet 35P, forming the positive electrode 3, or the electrode sheet 35N, forming the negative electrode 4.

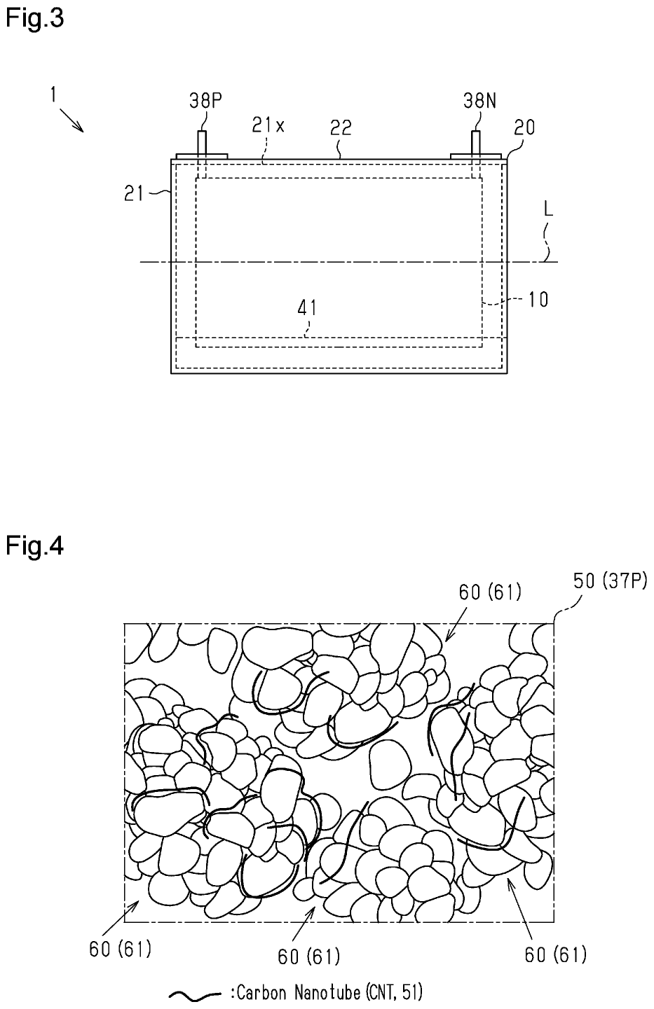

As shown in FIGS. 1 to 3, the lid 22 of the case 20 is provided with a positive terminal 38P and a negative terminal 38N projecting outward from the case 20. Each electrode sheet 35 also includes a non-applied portion 39, that is, a portion of the current collector 31 that is free of the electrode active material layer 32. In the rechargeable battery 1 of the present embodiment, the non-applied portions 39 are used to electrically connect the electrode sheet 35P, forming the positive electrode 3, to the positive terminal 38P and the electrode sheet 35N, forming the negative electrode 4, to the negative terminal 38N, respectively.

More specifically, in the present embodiment, the lid 22 is rectangular-plate-shaped. When the roll axis L extends in the longitudinal direction (sideward direction in FIG. 1) of the lid 22, the electrode body 10 is accommodated in the case 20. In this state, the non-applied portion 39P of the electrode sheet 35P, which forms the positive electrode 3, is connected to the positive terminal 38P by a connection member 40P. In the same manner, the non-applied portion 39N of the electrode sheet 35N, forming the negative electrode 4, is connected to the negative terminal 38N by a connection member 40N.

An electrolytic solution 41 is added to the case 20. In the present embodiment of the rechargeable battery 1, the electrolytic solution 41 is fluorine-based and is obtained by dissolving a lithium salt serving as a supporting salt in an organic solvent. In the rechargeable battery 1 of the present embodiment, the electrode body 10, which is sealed in the case 20, is impregnated with the electrolytic solution 41.

Electrode Mixture

An electrode mixture that is used to form the present embodiment of the rechargeable battery 1 will now be described.

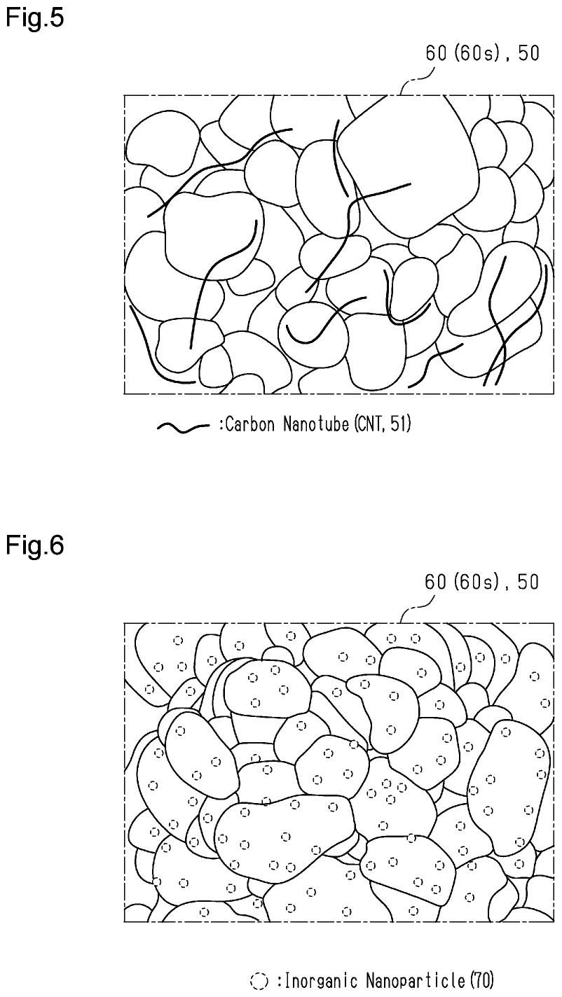

As shown in FIGS. 4 and 5, in the present embodiment of the rechargeable battery 1, an electrode mixture 50 is used to form the electrode body 10, more specifically, the positive active material layer 32P, which is the positive electrode 3 of the electrode body 10. The electrode mixture 50 includes carbon nanotubes CNT, which correspond to a conductive fibrous carbon material 51. More specifically, when the electrode mixture 50 is in the state of the mixture paste 37P as described above, the electrode mixture 50 is applied to the positive current collector 31P (refer to FIG. 2). In the present embodiment of the electrode mixture 50, the carbon nanotubes CNT, contained in the electrode mixture 50, are dispersed in the electrode mixture 50. In the present embodiment of the electrode mixture 50, the carbon nanotubes CNT form a conductive path for an electrode active material 60 located near the carbon nanotubes CNT, namely, a positive active material 61, that is, the electrode active material 60 for the positive electrode 3.

In the present embodiment of the electrode mixture 50, the positive active material 61 includes primary particles, corresponding to the smallest division unit (aggregate) of an assemblage of lithium-transition metal oxide, and secondary particles, corresponding to an assemblage of primary particles, that is, a particle assemblage (agglomerate). The carbon nanotubes CNT adhere to the surfaces of the secondary particles and are dispersed in the electrode mixture 50.

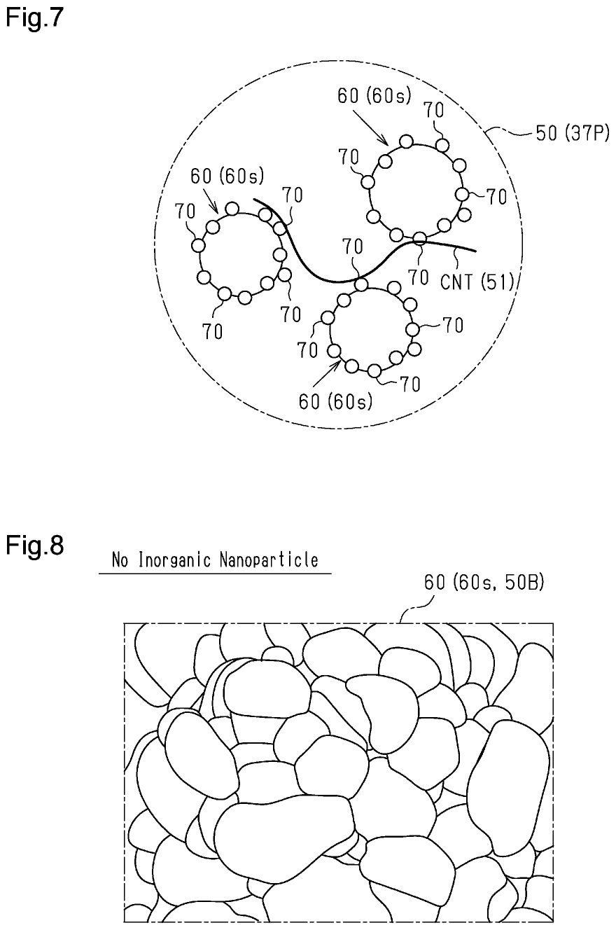

As shown in FIGS. 6 and 7, the present embodiment of the electrode mixture 50 further includes inorganic nanoparticles 70 adhered to a surface 60s of the electrode active material 60. In FIG. 6, the circles with broken lines indicate the inorganic nanoparticles 70 adhered to the surface 60s of the electrode active material 60. Thus, the present embodiment of the electrode mixture 50 is configured to inhibit aggregation of the fibrous carbon nanotubes CNT, thereby increasing the dispersibility of the fibrous carbon nanotubes CNT.

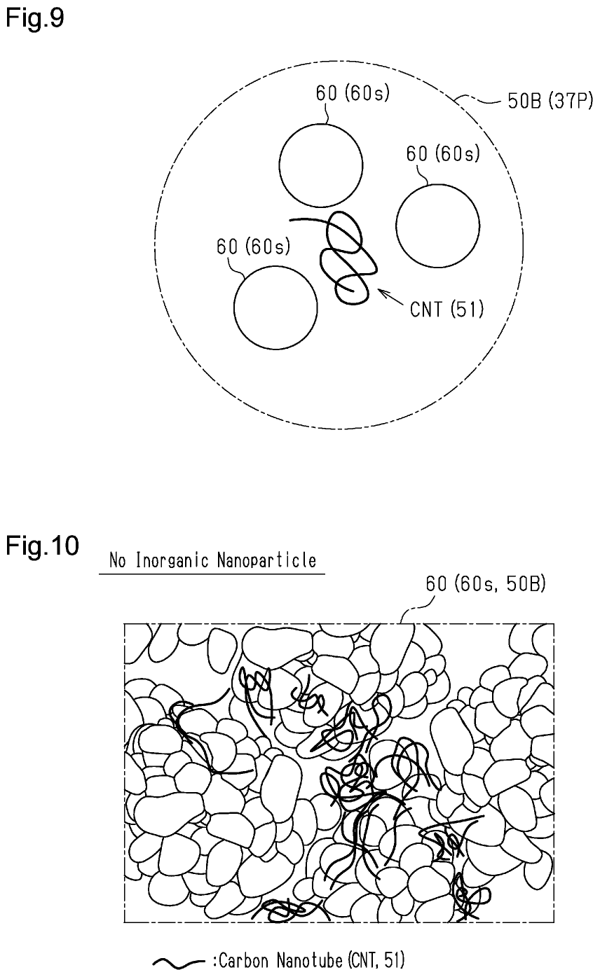

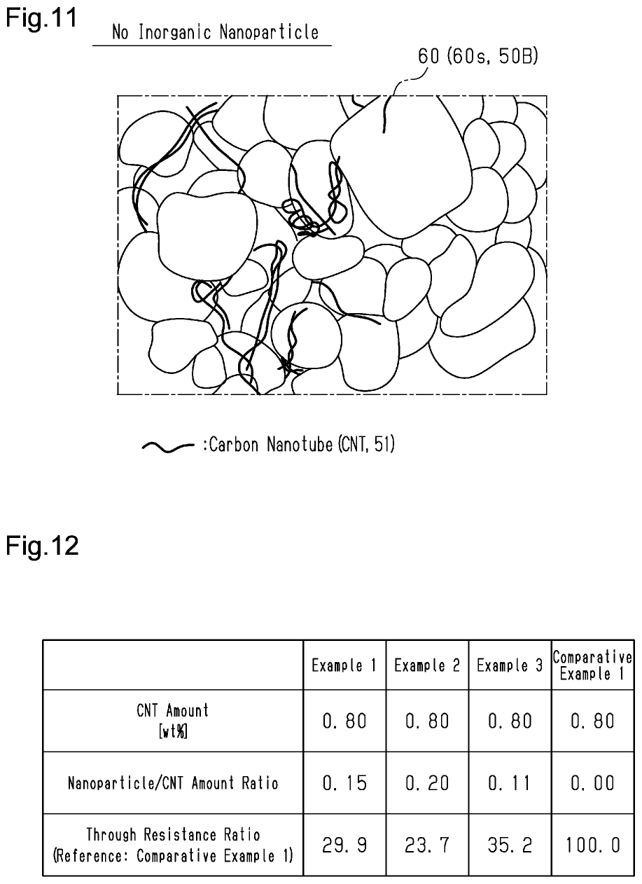

More specifically, as shown in FIGS. 8 to 11, when the carbon nanotubes CNT are added to an electrode mixture 50B that does not include the inorganic nanoparticles 70, the carbon nanotubes CNT tend to aggregate and form clusters in the electrode mixture 50B. As a result, the carbon nanotubes CNT are locally disposed in the electrode mixture 50B. This may hamper effective formation of a conductive path for the electrode active material 60.

In contrast, as shown in FIG. 7, in the present embodiment of the electrode mixture 50, the inorganic nanoparticles 70 are disposed on the surfaces 60s of the electrode active material 60 and adhere to the carbon nanotubes CNT contained in the electrode mixture 50. More specifically, the inorganic nanoparticle 70 has a tendency to adhere to neighboring carbon nanotubes CNT due to its intermolecular force. In addition, in the present embodiment of the electrode mixture 50, the inorganic nanoparticles 70, disposed on the surfaces 60s of the electrode active material 60, form a number of adhesion points with a single carbon nanotube CNT. In the present embodiment of the electrode mixture 50, when the carbon nanotubes CNT are dispersed in the electrode mixture 50, the carbon nanotubes CNT extend without aggregating and forming clusters. Thus, the carbon nanotubes CNT effectively form a conductive path for the electrode active material 60.

More specifically, in the present embodiment of the electrode mixture 50, the inorganic nanoparticles 70 may be formed from, for example, alumina, lithium tungstate, or the like. The inorganic nanoparticles 70 may have a particle diameter of, for example, greater than or equal to 25 nm and less than or equal to 150 nm. For example, when the amount of the inorganic nanoparticles 70 contained in the electrode mixture 50 is expressed in weight percent (wt %), it is preferred that the amount is set to an amount obtained from the following equation, where y denotes the amount of the inorganic nanoparticles 70 contained, and x denotes the average diameter of the inorganic nanoparticles 70.

y≤0.0106x−0.0033 Equation 1:

In the viewpoint of forming a number of adhesion points on a single carbon nanotube CNT so that the carbon nanotube CNT extends, it is advantageous when the electrode mixture 50 includes a large number of inorganic nanoparticles 70 so that the inorganic nanoparticles 70 are located adjacent to one another. However, when the surfaces 60s of the electrode active material 60 are covered by the large number of inorganic nanoparticles 70, the battery reaction may be inhibited.

In this regard, Equation 1 is designed to calculate an appropriate amount of the inorganic nanoparticles 70 that are disposed on the surfaces 60s of the electrode active material 60 and are less likely to inhibit the battery reaction. When the amount of the inorganic nanoparticles 70 contained is set based on calculation using Equation 1, the inorganic nanoparticles 70 allow for effective formation of a conductive path for the electrode active material 60 while avoiding a situation in which the battery reaction is inhibited by the inorganic nanoparticles 70 as described above.

In inhibition of the battery reaction caused by the inorganic nanoparticles 70 covering the surfaces 60s of the electrode active material 60, for example, when the inorganic nanoparticles 70 cover 10% or more of the surfaces 60s of the electrode active material 60, the battery output is significantly decreased by increases in the reaction resistance. In this regard, Equation 1 is designed to calculate an amount of the inorganic nanoparticles 70 contained in the electrode mixture 50 so that the inorganic nanoparticles 70 disposed on the surfaces 60s of the electrode active material 60 will not cover 10% or more of the surfaces 60s of the electrode active material 60. Thus, in the present embodiment of the electrode mixture 50, the inorganic nanoparticles 70 disposed on the surface 60s of the electrode active material 60 are effective in improving the properties of the battery.

More specifically, the carbon nanotubes CNT may have an average length of, for example, greater than or equal to 100 nm and less than or equal to 1000 nm.

When the carbon nanotubes CNT have an insufficient length, a sufficient conductivity cannot be obtained. When the carbon nanotubes CNT have an excessive length, the carbon nanotubes CNT may aggregate due to intermolecular force and hydrogen bond. In this case, a sufficient conductivity cannot also be obtained.

The carbon nanotubes CNT may have an average diameter of, for example, greater than or equal to 1 nm and less than or equal to 100 nm.

More specifically, an excessively small diameter of a carbon nanotube CNT lowers the probability that the inorganic nanoparticles 70, disposed on the surfaces 60s of the electrode active material 60, adhere to the carbon nanotube CNT. Also, an excessively large diameter of a carbon nanotube CNT lowers the probability of adhesion of the inorganic nanoparticles 70 to the carbon nanotube CNT.

The amount of the carbon nanotubes CNT contained in the electrode mixture 50 may be set to, for example, greater than or equal to 0.5 wt % and less than or equal to 2.0 wt %. In this case, it is preferred that the weight ratio of the inorganic nanoparticles 70 to the carbon nanotubes CNT is greater than or equal to 0.1 and less than or equal to 0.7.

More specifically, when the weight ratio of the inorganic nanoparticles 70 to the carbon nanotubes CNT is excessively low, that is, when the contained amount of the inorganic nanoparticles 70 is excessively small as compared to the contained amount of the carbon nanotubes CNT, the probability that the inorganic nanoparticles 70 adhere to the carbon nanotubes CNT in the electrode mixture 50 will be lower. When the weight ratio of the inorganic nanoparticles 70 to the carbon nanotubes CNT is excessively high, that is, when the contained amount of the inorganic nanoparticles 70 is excessively large as compared to the contained amount of the carbon nanotubes CNT, the excess inorganic nanoparticles 70 may inhibit the battery reaction.

The diameter ratio of the inorganic nanoparticles 70 to the carbon nanotubes CNT contained in the electrode mixture 50 may be, for example, greater than or equal to 1.1 and less than or equal to 3.5.

More specifically, when the diameter ratio of the inorganic nanoparticles 70 to the carbon nanotubes CNT is excessively low, that is, when the particle diameter of the inorganic nanoparticles 70 is excessively small as compared to the particle diameter of the carbon nanotubes CNT, the probability that the inorganic nanoparticles 70 adhere to the carbon nanotubes CNT in the electrode mixture 50 will be lower. Also, when the diameter ratio of the inorganic nanoparticles 70 to the carbon nanotubes CNT is excessively high, that is, when the particle diameter of the inorganic nanoparticles 70 is excessively large as compared to the particle diameter of the carbon nanotubes CNT, the probability that the inorganic nanoparticles 70 adhere to the carbon nanotubes CNT in the electrode mixture 50 will be lower.

The present embodiment of the electrode mixture 50 may be implemented by combining, in any manner, the above-described technical features related to the inorganic nanoparticles 70 and the carbon nanotubes CNT used for adjusting the electrode mixture 50.

In particular, preferred ranges of the particle diameter of the inorganic nanoparticles 70, Equation 1, which calculates a contained amount of the inorganic nanoparticles 70 in accordance with the average diameter, and the weight ratio and the diameter ratio of the inorganic nanoparticles 70 to the carbon nanotubes CNT may be combined. This produces synergy effects and is further effective in improving the properties of the battery.

Operation

The operation of the present embodiment will now be described.

The inorganic nanoparticles 70, disposed on the surfaces 60s of the electrode active material 60, adhere to the carbon nanotubes CNT in the electrode mixture 50. This extends the carbon nanotubes CNT. As a result, aggregation of the carbon nanotubes CNT contained in the electrode mixture 50 is inhibited.

The advantages of the present embodiment will now be described.

(1) The electrode mixture 50 includes the electrode active material 60 and the carbon nanotubes CNT, which correspond to the conductive fibrous carbon material 51. The electrode mixture 50 further includes the inorganic nanoparticles 70, disposed on the surfaces 60s of the electrode active material 60.

With this structure, the carbon nanotubes CNT are extended and dispersed in the electrode mixture 50 without aggregating and forming clusters. The carbon nanotubes CNT effectively form a conductive path for the electrode active material 60 and ensure high performance properties of the battery.

(2) The average diameter of the inorganic nanoparticles 70 is greater than or equal to 25 nm and less than or equal to 150 nm.

With this structure, the inorganic nanoparticles 70, disposed on the surface 60s of the electrode active material 60, tend to adhere to the carbon nanotubes CNT contained in the electrode mixture 50. Thus, the carbon nanotubes CNT effectively form a conductive path for the neighboring active material 60 in the electrode mixture 50.

(3) When expressed in weight percent (wt %), the amount of the inorganic nanoparticles 70 contained in the electrode mixture 50 is obtained by Equation 1 described above, where y denotes the contained amount of the inorganic nanoparticles 70, and x denotes the average diameter of the inorganic nanoparticles 70.

When the contained amount is set based on calculation using Equation 1, the inorganic nanoparticles 70, covering the surfaces 60s of the electrode active material 60, do not inhibit the battery reaction. In addition, the inorganic nanoparticles 70, disposed on the surfaces 60s of the electrode active material 60, allow for effective formation of a conductive path for the neighboring electrode active material 60. This is further effective in improving the properties of the battery.

(4) The amount of the carbon nanotubes CNT contained in the electrode mixture 50 is greater than or equal to 0.5 wt % and less than or equal to 2.0 wt %. The weight ratio of the inorganic nanoparticles 70 to the carbon nanotubes CNT is greater than or equal to 0.1 and less than or equal to 0.7.

With this structure, the ratio of the contained amount of the inorganic nanoparticles 70 to the contained amount of the carbon nanotubes CNT is appropriately set. Thus, the inorganic nanoparticles 70 efficiently adhere to the carbon nanotubes CNT in the electrode mixture 50, while avoiding inhibition of the battery reaction caused by the excess inorganic nanoparticles 70. This is further effective in improving the properties of the battery.

(5) The diameter ratio of the inorganic nanoparticles 70 to the carbon nanotubes CNT is greater than or equal to 1.1 and less than or equal to 3.5.

With this structure, the ratio of the particle diameter of the inorganic nanoparticles 70 to the diameter of the carbon nanotubes CNT is appropriately set. Thus, the inorganic nanoparticles 70 efficiently adhere to the carbon nanotubes CNT in the electrode mixture 50. This is further effective in improving the properties of the battery.

The above embodiment may be modified as described below. The embodiment and the following modified examples may be combined within a scope in which the combined modified examples remain technically consistent with each other.

In the embodiment described above, the carbon nanotubes CNT are used as the conductive fibrous carbon material 51. Alternatively, the conductive fibrous carbon material 51 may be, for example, carbon nanofibers (CNF) or other fibrous carbon materials that have conductivity and form a conductive path for the neighboring electrode active material 60 in the electrode mixture 50.

The inorganic nanoparticles 70 may include alumina, lithium tungsten, or both of alumina and lithium tungsten. The inorganic nanoparticles 70 may include other substances.

Other examples of the substances used as the inorganic nanoparticles 70, disposed on the surfaces 60s of the electrode active material 60, include metallic oxides such as zirconium oxide, titanium oxide, niobium oxide, molybdenum oxide, magnesium oxide, or tungsten oxide. Other examples of the substances used as the inorganic nanoparticles 70 include a fluoride such as aluminum fluoride or lithium fluoride, lithium nickel oxide, or lithium cobalt oxide. Preferably, the inorganic nanoparticles 70 are sufficiently smaller in particle diameter than the electrode active material 60 so that a number of inorganic nanoparticles 70 adhere to a carbon nanotube CNT in the electrode mixture 50.

The electrode mixture 50, which is used as the base, may have any structure. In an example, the lithium-transition metal oxide forming the electrode active material 60 may have any composition. The primary particle and the secondary particle of the lithium-transition metal oxide may have any diameter. A binder that is added to the electrode mixture 50 may be of any type and have any physical properties. The electrode mixture 50 may include any additive agent. In an example, the electrode mixture 50 may have a structure in which the electrode active material 60 is supported by only the conductive fibrous carbon material 51 without using a typical binder.

The particle diameter of the inorganic nanoparticles 70, the amount of the inorganic nanoparticles 70 contained in the electrode mixture 50, the length and the diameter of the carbon nanotubes CNT, and the amount of the carbon nanotubes CNT contained in the electrode mixture 50 may be set in any manner. The weight ratio and the diameter ratio of the inorganic nanoparticles 70 to the carbon nanotubes CNT may also be set in any manner. That is, the numerical ranges and the equation described in the embodiment are preferred examples and do not necessarily impose a limitation. In an example, the numerical ranges and the equation described in the embodiment may be set in any manner in accordance with the structure of the electrode mixture 50, used as the base, such as whether or not to add a binder, the type and physical properties of a binder, and the specifications of the electrode active material 60.

In the embodiment, the electrode mixture 50 is for a positive electrode and is used to form the positive active material layer 32P. Alternatively, the embodiment may include an electrode mixture 50 for a negative electrode used to form the negative active material layer 32N if the electrode mixture 50 includes particles of the electrode active material 60, the conductive fibrous carbon material 51, and the inorganic nanoparticles 70 disposed on the surfaces 60s of the electrode active material 60.

In the embodiment, the electrode mixture 50 is used to form the rechargeable battery 1 having a structure of a lithium-ion rechargeable battery. Instead, the embodiment may be used for a rechargeable battery 1 other than a lithium-ion rechargeable battery.

The shapes of the positive terminal 38P and the negative terminal 38N are not limited to those shown in FIG. 1 and may be changed in any manner. The shape of the case 20, which defines the outer shape of the rechargeable battery 1, is not limited to a low-profile rectangular box and may be changed in any manner, for example, to a cylinder.

### EXAMPLES

Examples will now be described to further specify the structure and advantages of the present disclosure. However, the present invention is not limited to the examples.

Weight Ratio of Inorganic Nanoparticles 70 to Carbon Nanotubes CNT

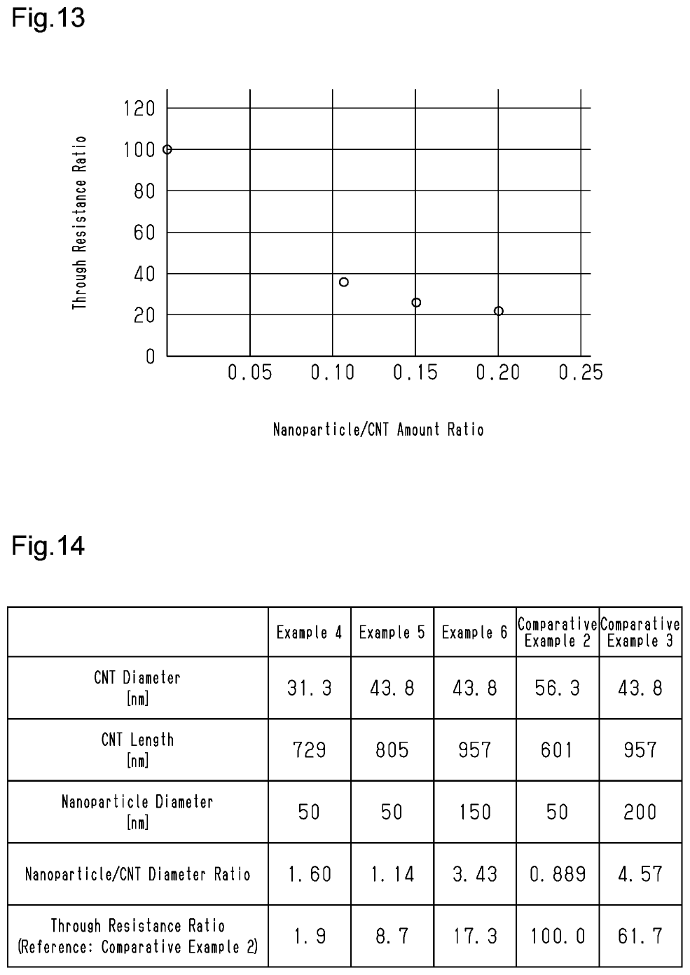

FIGS. 12 and 13 are a table and a graph showing the effect of improvement of the properties of the battery related to the content of the inorganic nanoparticles 70 and the test results related to the weight ratio of the inorganic nanoparticles 70 to the carbon nanotubes CNT. Alumina particles are used as the inorganic nanoparticles 70.

In FIGS. 12 and 13, the “through resistance ratio” shows results of an electrode sheet through resistance test conducted on the electrode sheet 35 formed from the electrode mixture 50 in a ratio of the test result of each example to the test result of a comparative example being 100. Also, the “through resistance” may refer to the “sheet penetration resistance. In this specification, the “through resistance” indicates an electric resistance of the electrode sheets 35 in the thickness-wise direction, that is, a sum of an electric resistance of the electrode mixture, an electric resistance of an interface, an electric resistance of a current collector foil, and the like of the electrode sheet 35 in the thickness direction. That is, the electrode sheet through resistance test results indicate that the smaller the value of the test result is, the better the properties of the battery are. Accordingly, the “through resistance ratio” also indicates that the smaller the value of the through resistance ratio is, the better the properties of the battery are.

As shown in FIGS. 12 and 13, the electrode mixture 50 contains 0.8 wt % of the carbon nanotubes CNT in each of examples 1 to 3 and comparative example 1, which is the reference of the “through resistance ratio”. In comparative example 1, the electrode mixture 50 does not contain the inorganic nanoparticles 70. In examples 1 to 3, the weight ratio of the inorganic nanoparticles 70 to the carbon nanotubes CNT is 0.15, 0.20, and 0.11, respectively.

Under the condition described above, the through resistance ratio is 29.9, 23.7, and 35.2 in examples 1 to 3, respectively, and is lower than comparative example 1, used as the reference. The results indicate that the electrode mixture 50 containing the inorganic nanoparticles 70, disposed on the surfaces 60s of the electrode active material 60, improves the properties of the battery.

The value of the through resistance ratio is increased in the order of examples 3, 1, and 2, in which the weight ratio of the inorganic nanoparticles 70 to the carbon nanotubes CNT is decreased. As the weight ratio of the inorganic nanoparticles 70 to the carbon nanotubes CNT becomes lower, the degree of improvement from comparative example 1, which does not include the inorganic nanoparticles 70, is decreased. From this tendency, it is preferred that the weight ratio of the inorganic nanoparticles 70 to the carbon nanotubes CNT has a lower limit value that is, for example, greater than or equal to 0.1.

It is assumed from the plot shown in FIG. 13 that the value of the through resistance ratio linearly increases as the weight ratio becomes lower in a region where the weight ratio of the inorganic nanoparticles 70 to the carbon nanotubes CNT is lower than 0.1. The lower limit value of the weight ratio of the inorganic nanoparticles 70 to the carbon nanotubes CNT may be extended and set to, for example, approximately “greater than or equal to 0.07” or “greater than or equal to 0.05”.

The upper limit value of the weight ratio of the inorganic nanoparticles 70 to the carbon nanotubes CNT may be obtained using Equation 1 shown in the embodiment described above. For example, when the average diameter of the inorganic nanoparticles 70 is x=50 nm, Equation 1 calculates that a preferred amount of the inorganic nanoparticles 70 contained in the electrode mixture 50 is less than or equal to 0.53 wt %. When the amount of the carbon nanotubes CNT contained in the electrode mixture 50 is 0.8 wt % as in examples and comparative example, the weight ratio of the inorganic nanoparticles 70 to the carbon nanotubes CNT is approximately 0.66. This verifies that “less than or equal to 0.7”, described in the embodiment, is a valid upper limit value of the weight ratio.

Diameter Ratio of Inorganic Nanoparticle 70 to Carbon Nanotube CNT

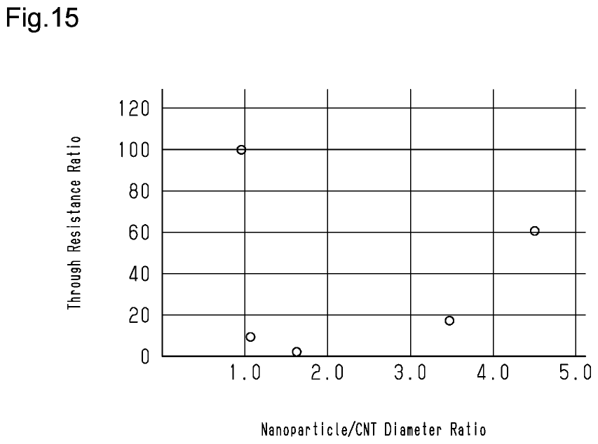

FIGS. 14 and 15 are a table and a graph showing test results related to the diameter ratio of the inorganic nanoparticles 70 to the carbon nanotubes CNT.

Alumina particles are used as the inorganic nanoparticles 70. In examples 4 to 6 and comparative examples 2 and 3, the amount of the carbon nanotubes CNT contained in the electrode mixture 50 is 0.8 wt %. The weight ratio of the inorganic nanoparticles 70 to the carbon nanotubes CNT is adjusted to 0.15. In FIGS. 14 and 15, the values of the “through resistance ratio” shows a ratio when the test result of comparative example 2 is 100.

As shown in FIGS. 14 and 15, the diameter (nm) of the carbon nanotubes CNT is 31.3, 43.8, 43.8, 56.3, and 43.8 in examples 4 to 6 and comparative examples 2 and 3 in the order from the left in FIG. 14. Also, the length (nm) of the carbon nanotubes CNT is 729, 805, 957, 601, and 957 in examples and comparative examples in the order from the left in FIG. 14. In addition, in examples and comparative examples, the particle diameter of the inorganic nanoparticles 70 is 50 nm in examples 4 and 5 and comparative example 2, and 150 nm in example 5, and 200 nm in comparative example 3. Thus, the diameter ratio of the inorganic nanoparticles 70 to the carbon nanotubes CNT is 1.60, 1.14, 3.43, 0.889, and 4.57 in examples and comparative examples in the order from the left in FIG. 14.

Under the condition described above, the through resistance ratio is 1.9, 8.7, and 17.3, in examples 4 to 6, respectively, and is lower than comparative example 2, used as the reference. In comparative example 3, the through resistance ratio is 61.7. From this tendency, it is preferred that the diameter ratio of the inorganic nanoparticles 70 to the carbon nanotubes CNT has a lower limit value that is, for example, greater than or equal to 1.1. Also, it is preferred that the diameter ratio has an upper limit value that is, for example, less than or equal to 3.5. The test results also verify that “greater than or equal to 1.1 and less than or equal to 3.5”, described in the embodiment, is a valid, preferred setting range of the diameter ratio.

It is assumed from the plot shown in FIG. 15 that the value of the through resistance ratio linearly increases as the diameter ratio becomes higher in a region where the diameter ratio of the inorganic nanoparticles 70 to the carbon nanotubes CNT is higher than approximately 3.0. Thus, it is more preferred that the diameter ratio of the inorganic nanoparticles 70 to the carbon nanotubes CNT has an upper limit value that is set to, for example, “less than or equal to 3.4” or “less than or equal to 3.0”. The lower limit value of the diameter ratio may be extended and set to, for example, less than or equal to approximately 4.0.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An electrode mixture, comprising:
an electrode active material;
a conductive fibrous carbon material; and
an inorganic nanoparticle disposed on a surface of the electrode active material.

2. The electrode mixture according to claim 1, wherein the inorganic nanoparticle has an average diameter of greater than or equal to 25 nm and less than or equal to 150 nm.

3. The electrode mixture according to claim 2, wherein when an amount of the inorganic nanoparticle contained in the electrode mixture is expressed in weight percent, the amount of the inorganic nanoparticle contained in the electrode mixture is expressed by an equation of y≤0.0106x−0.0033, where y denotes the amount of the inorganic nanoparticle contained, and x denotes the average diameter of the inorganic nanoparticle.

4. The electrode mixture according to claim 1, wherein
an amount of the conductive fibrous carbon material contained in the electrode mixture is greater than or equal to 0.5 wt % and less than or equal to 2.0 wt %, and
a weight ratio of the inorganic nanoparticle to the conductive fibrous carbon material is greater than or equal to 0.1 and less than or equal to 0.7.

5. The electrode mixture according to claim 1, wherein a diameter ratio of the inorganic nanoparticle to the conductive fibrous carbon material is greater than or equal to 1.1 and less than or equal to 3.5.

6. The electrode mixture according to claim 1, wherein the conductive fibrous carbon material includes a carbon nanotube.

7. The electrode mixture according to claim 1, wherein the inorganic nanoparticle includes at least one of alumina and lithium tungstate.

8. A rechargeable battery manufactured using the electrode mixture according to claim 1.

9. A rechargeable battery manufactured using an electrode mixture including an electrode active material and a conductive fibrous carbon material, wherein
the electrode mixture includes an inorganic nanoparticle disposed on a surface of the electrode active material,
the inorganic nanoparticle has an average diameter of greater than or equal to 25 nm and less than or equal to 150 nm,
when an amount of the inorganic nanoparticle contained in the electrode mixture is expressed in weight percent, the amount of the inorganic nanoparticle contained in the electrode mixture is expressed by an equation of y≤0.0106x−0.0033, where y denotes the amount of the inorganic nanoparticle contained, and x denotes the average diameter of the inorganic nanoparticle,
an amount of the conductive fibrous carbon material contained in the electrode mixture is greater than or equal to 0.5 wt % and less than or equal to 2.0 wt %,
a weight ratio of the inorganic nanoparticle to the conductive fibrous carbon material is greater than or equal to 0.1 and less than or equal to 0.7, and
a diameter ratio of the inorganic nanoparticle to the conductive fibrous carbon material is greater than or equal to 1.1 and less than or equal to 3.5.
